(19) United States
(12) Patent Application Publication
(10) Pub. No.: US 2006/0128592 A1
(43) Pub. Date: Jun. 15, 2006

(54) Cosmetic effervescent cleansing pillow with water soluble or dispersible packet

(75) Inventors: Michael Edward Ross, Naperville, IL (US); James Lynn Turbett, Darien, CT (US); Shauna Mary Lagatol, New Haven, CT (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division Of Conopco, Inc.

(21) Appl. No.: 11/009,659

(22) Filed: Dec. 10, 2004

(51) Int. Cl. C11D 17/00

(52) U.S. Cl. 510/439

(57) ABSTRACT

A cleansing article is provided which includes an effervescent cleanser composition held within a water-soluble packet and the packet is held within a receptacle formed from a first and second substrate sheet. At least a portion of one of the substrate sheets must be water permeable. The effervescent cleanser composition is an intimate mixture of an acid material such as citric acid, an alkaline material such as sodium bicarbonate, and a surfactant.

### BACKGROUND OF THE INVENTION

1. Field of the Invention

The present invention relates to a personal skin care and cleansing implement and specifically one that contains a water soluble or dispersible unitary packet with an effervescent cleansing composition.

2. The Related Art

Implements are frequently used to efficiently apply skin care and cleansing compositions and have included woven and nonwoven wipes, polymeric mesh bags and sponges to name a few widely used forms of implements.

An early example of cleansing pad technology is found in U.S. Pat. No. 1,808,834 (Busch Sr.). A fabric pouch is disclosed surrounding a cleansing composition mainly consisting of calcium and sodium carbonate.

U.S. Pat. No. 4,234,442 (Cornelissens) describes a sachet which can consist of a water permeable material filled with an acidic and an alkaline constituent. Adipic, succinic and glutaric acids exemplify the acidic constituent. Sodium bicarbonate and carbonate represent the alkaline ingredient.

U.S. Pat. No. 4,272,393 (Gergely) describes a cleaning article formed of a porous flexible substrate, especially a cellulosic paper, impregnated with detergent and a gas-generating system. The latter is formed by separating an acidic component such as citric acid from a basic component such as sodium carbonate in two separate areas of the substrate.

U.S. Pat. No. 4,515,703 (Haq), U.S. Pat. No. 4,600,620 (Lloyd et al.) and U.S. Pat. No. 4,603,069 (Haq et al.) all describe wiping articles impregnated with surfactant. These do not contain any effervescent ingredients.

WO 97/43366 (Askew et al.) reports an effervescent system to improve dispensability of granular laundry detergent powders into wash water of automatic washing machines. Citric acid and bicarbonate combinations are employed to generate effervescence.

U.S. Pat. No. 6,063,390 (Farrell et al.); U.S. Pat. No. 6,217,854 (Farrell et al.); U.S. Pat. No. 6,610,311 (Charambura et al.); U.S. Pat. No. 6,610,312 (Farrell et al.); and U.S. Publication no. 2003/0003136 all describe effervescent cosmetic pillows. However the articles disclosed therein do not employ water soluble or dispersible pouches to contain the effervescent cleansing compositions.

Surprisingly it has been found that a cleansing cloth containing an effervescent composition activated by contact with water can be provided where the effervescent composition is contained in a unitary chamber and where the composition can be activated with the addition of water.

### SUMMARY OF THE INVENTION

In one aspect of the invention is a cosmetic article for cleansing the skin and hair, the article including but not limited to:

a. a water permeable first substrate defining at least a portion of one wall of a receptacle;

b. a second substrate defining a unitary chamber positioned in the receptacle, the second substrate having a water soluble or dispersible portion;

c. an anhydrous effervescent cleanser composition being positioned within the unitary chamber, the composition including:
(i) from about 1 to about 80% of an alkaline material;
(ii) from about 0.5 to about 80% of an acid material;
(iii) from about 0.1 to about 30% of a surfactant; and wherein the alkaline and acid materials are blended together within the unitary chamber.

In another aspect of the invention is a cosmetic article for cleansing body surfaces, the article comprising a substantially sealed pillow plumped by effervescent generated carbon dioxide and exuding lather and an emollient through a water permeable first substrate wherein the article contains a second substrate defining a unitary chamber positioned in the pillow, the chamber containing an effervescent composition, and the second substrate having a water soluble or dispersible portion.

In a further aspect of the invention is a method for cleansing skin including but not limited to the steps of:

a. wetting with water a cosmetic cleansing article,

b. generating foam from the article and

c. wiping skin surfaces with the wetted article, wherein the article includes:
1. a water permeable first substrate defining at least a portion of one wall of a receptacle;
2. a second substrate defining a unitary chamber positioned in the receptacle, the substrate having a water soluble or dispersible portion;
3. an anhydrous effervescent cleanser composition being positioned within the unitary chamber, the composition including:
   (i) from about 1 to about 80% of an alkaline material;
   (ii) from about 0.5 to about 80% of an acid material;
   (iii) from about 0.1 to about 30% of a surfactant; and wherein the alkaline and acid materials are blended together within the unitary chamber.

### BRIEF DESCRIPTION OF THE DRAWINGS

FIG. 1 is a perspective diagram of a preferred embodiment of the cleansing article of the invention, parts being broken away for clarity.

FIG. 1A is a perspective diagram of a second preferred embodiment of the cleansing article of the invention, parts being broken away for clarity.

FIG. 2 is a vertical cross-sectional view of FIG. 1 taken along line 2-2.

FIG. 3 is a detailed vertical cross-sectional view of FIG. 1 taken along line 3-3 showing a portion of the unitary chamber being received by a portion of the water permeable substrate.

### DETAILED DESCRIPTION OF THE INVENTION

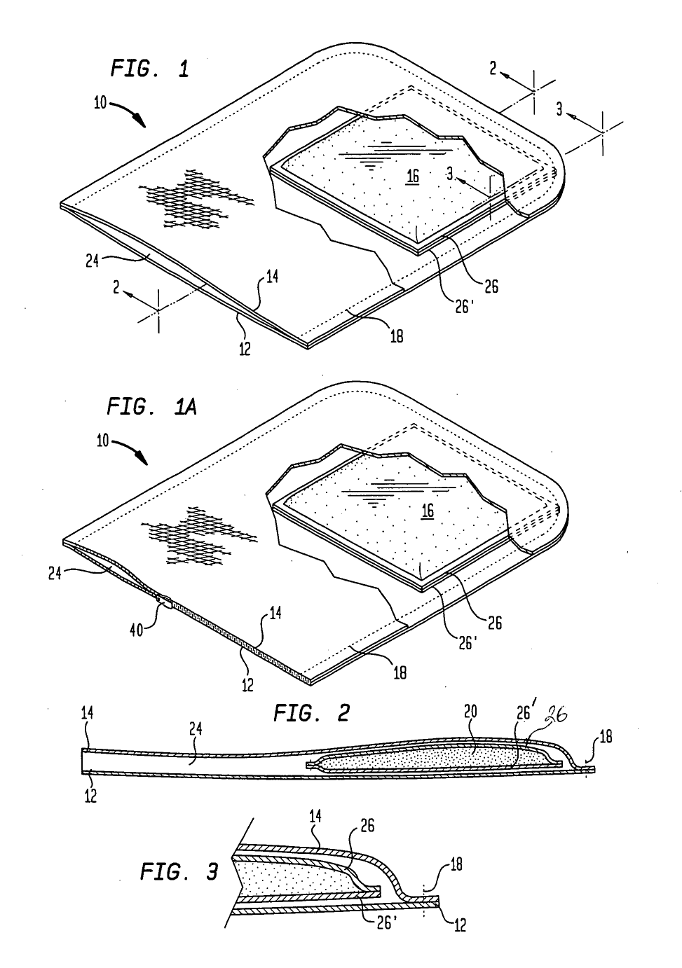

Now referring to the figures where like numbers represent like features, cosmetic article 10 is composed of first sheet 12 and second sheet 14, that are each individually water permeable first substrates attached via stitching 18 to form receptacle 24. Receptacle 24 is configured to receive packet 16. Packet 16 is composed of second substrates which are water soluble or dispersible membrane materials 26 and 26′ that contain effervescent cleansing composition 20 heat sealed within the membranes 26 and 26′. In a preferred embodiment, receptacle 24 is closed after packet 16 is inserted therein using any suitable permanent or reversible closure method such as heat sealing, spot welds, needle punching, stitching, interlocking closufre strips or points, Velcro® hooks and loops, buttons, zippers and the like. In a further preferred embodiment as shown in FIG. 1A, receptacle 24 employs sealing means such as zipper 40 that can be repeatably opened and closed by the user (i.e. reversible) to easily allow replacement of packet 16 with a fresh packet after packet 16 has been exhausted with use. In another preferred embodiment packet 16 may be attached to first sheet 12 and second sheet 14 via any suitable attachment means to form a single use disposable cosmetic article 10 where packet 16 is not readily replaceable after the cosmetic article has been used.

In one aspect of the invention is a cosmetic article for cleansing the skin and hair, the article including but not limited to:

a. a water permeable first substrate defining at least a portion of one wall of a receptacle (preferably where the receptacle is closable or sealable);

b. a second substrate defining a unitary chamber positioned in the receptacle, the second substrate having a water soluble or dispersible portion (preferably where the second substrate is substantially water soluble or dispersible);

c. an anhydrous effervescent cleanser composition being positioned within the unitary chamber, the composition including:
(i) from about 1 to about 80% of an alkaline material;
(ii) from about 0.5 to about 80% of an acid material;
(iii) from about 0.1 to about 30% of a surfactant; and wherein the alkaline and acid materials are blended together within the unitary chamber. (preferably wherein the effervescent cleanser composition is sealed within the unitary chamber).

Advantageously the first substrate is selected from woven or nonwoven materials; other natural or synthetic polymeric materials, or any combination of the foregoing such as apertured formed thermoplastic films, apertured plastic films, and hydroformed thermoplastic films; mesh composed of polymeric filaments (e.g. diamond mesh netting, etc.), natural sponge, porous foams; reticulated foams (e.g. polyurethane, regenerated cellulose, etc.); reticulated thermoplastic films; and thermoplastic scrims and the like and equivalents thereof). Preferably the first substrate is a fibrous substrate and the second substrate is selected from natural or synthetic water-soluble materials or a blend thereof.

Preferably the second substrate is selected from polyvinyl alcohol, cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcelulose, polyacrylic acid salts, alginates, acrylamide copolymers, guar gum, casein, ethylene-maleic anhydride resin series, polyethyleneimine, ethyl hydroxyethylcellulose, ethyl methylcellulose, hydroxyethyl methylcellulose, esters of polyvinyl alcohol, lactic acid ethers or esters of cellulose derivatives, lactic acid grafts on polyvinyl alcohol, carrageenan, pectin, or combinations, derivatives or equivalents thereof.

Advantageously the second substrate has an average thickness in the range of about 10 to 125 microns (preferably about 25 to 50 microns, most preferably about 25 to 35 microns).

In a preferred embodiment the effervescent cleanser composition further includes from about 0.01 to about 30% by weight of a skin benefit agent selected from emollients, anti-aging actives, antibacterials and fungicides, skin lighteners, sunscreens or mixtures thereof. Preferably the anti-aging actives are selected from vitamins, retinoids or mixtures thereof. More preferably the cleanser composition further includes about 0.1 to about 3% by weight of an emotive agent selected from the group consisting of fragrance, botanical extracts or mixtures thereof. In a further preferred embodiment the emotive agent is incorporated into the effervescent cleanser composition by spray application onto one or more other components of the composition.

Preferably the water permeable first substrate is a non-woven rayon and the second substrate defining the unitary chamber is a water soluble polyvinyl alcohol polymer. More preferably the surfactant in the cleansing composition includes sodium cocoyl isethionate and the acid includes citric acid. More preferably the effervescent cleanser composition further includes about 0.01 to about 1% by weight of a skin deposition aid which is a cationic monomer or polymer.

In another aspect of the invention is a cosmetic article for cleansing body surfaces, the article comprising a substantially sealed pillow plumped by effervescent generated carbon dioxide and exuding lather and an emollient through a water permeable first substrate wherein the article contains a second substrate defining a unitary chamber positioned in the pillow, the chamber containing an effervescent composition, and the second substrate having a water soluble or dispersible portion.

In a further aspect of the invention is a method for cleansing skin including but not limited to the steps of:

a. wetting with water a cosmetic cleansing article,

b. generating foam from the article and

c. wiping skin surfaces with the wetted article, wherein the article includes:
1. a water permeable first substrate defining at least a portion of one wall of a receptacle (preferably where the receptacle is closable or sealable);
2. a second substrate defining a unitary chamber positioned in the receptacle, the substrate having a water soluble or dispersible portion;
3. an anhydrous effervescent cleanser composition being positioned within the unitary chamber, the composition including:
   (i) from about 1 to about 80% of an alkaline material;
   (ii) from about 0.5 to about 80% of an acid material;
   (iii) from about 0.1 to about 30% of a surfactant; and wherein the alkaline and acid materials are blended together within the unitary chamber.
      Water Soluble or Dispersible Films:

A soluble or dispersible film is defined as that which dissolves or disperses over a period of time when immersed in water at 25 C such that the contents are released and are contacted with water. Advantageously this time can be in the range of about 4 to 12 seconds while immersed in water whereupon the contents of the packet containing the film are released, especially when accompanied by mechanical manipulation (squeezing, kneading, or similar motion) by the user of the implement. The time may be shortened if water of elevated temperature is used. Release is here defined as discharging or dissolving at least about 50% of the packet's contents in about 5 to 7 seconds when the packet is agitated in water of 25 C temp.

The materials that may be used to make the water soluble packets of this invention include those which may generally be classified as water soluble resins, such as film-forming water soluble resins. Suitable water-soluble resins which may be used in the invention include 38 micron (1.5 mil) polyvinyl alcohol (PVOH) film grade M9500 from Monosol, LLC (Portage, Ind.). Other suitable resins are described in Davidson and Sittig, Water—Soluble Resins, Van Nostrand Reinhold Company, New York (1968), herein incorporated by reference. The water-soluble resin should have proper characteristics such as sufficient water solubility to quickly release the contents stored within the chamber defined by the resin, and sufficient strength and pliability in order to permit machine handling while filling and packaging without tearing. Monosol M9500 cold water-soluble polyvinyl alcohol is a useful material having a disintegration time of 7 seconds and a dissolution time of 18 seconds in 24 C distilled water (MSTM 205 test method, Monosol) for a 38 micron thick film. Other preferred water-soluble resins include polyvinyl alcohol, cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcelulose, polyacrylic acid salts, alginates, acrylamide copolymers, guar gum, casein, ethylene-maleic anhydride resin series, polyethyleneimine, ethyl hydroxyethylcellulose, ethyl methylcellulose, hydroxyethyl methylcellulose. Lower molecular weight water-soluble, polyvinyl alcohol film-forming resins are generally preferred.

The generally preferred water-soluble, polyvinyl alcohol film-forming resins should, in addition to low weight average molecular weights, have low levels of hydrolysis in water. Polyvinyl alcohols preferred for use herein have a weight average molecular weight between about 1,000 and about 300,000, and preferably, between about 2,000 and about 150,000, and most preferably, between about 3,000 and about 100,000, including all ranges subsumed therein. Even further, it is within the scope of this invention to include polyvinyl alcohol films which are copolymers such as films prepared from vinyl acetate and methacrylic acid precursor monomers. Preferred copolymers typically comprise less than about 15.0% by weight methacrylic acid units in their backbone.

As is known in the art, suitable water soluble or dispersible films, such as e.g. PVOH films, have an optimal range of thickness and pore size distribution that simultaneously allows quick dissolution or dispersion of the film during use of the inventive article while not allowing potentially objectionable amounts of fines from the composition contained within the packet to leak out nor allowing the transmission of too much humidity to the powder stored within the packet. The disadvantage of allowing too much humidity to pass through will be that premature activation of the effervescent composition and/or clumping of the composition may occur. The disadvantage of using a thicker film layer to protect the composition from outside humidity would be that the film would not dissolve quickly enough and release its contents so that they dissolve in water creating effervescence and causing the receptacle to expand with the resulting gas. Additionally such an article may leave a sticky feeling on the skin of the user. The present invention includes all such optimum ranges of thickness and porosity that improve user qualities allowing quick release, adequate humidity protection and minimal stickiness.

Cosmetic wiping articles of the present invention when contacted with water advantageously billow to many times (preferably more than 10 but more preferably more than 40 times) their size prior to being activated by water. The effervescent cleansing system exudes copious amounts of lather. A plumped “pillow” arises from the effervescent action. By careful control of the acidic and alkaline components, a squeaky clean rinsed feeling is felt on a user's skin.

Effervescent Cleanser Composition:

A first essential component of compositions within the packet is that of an acidic material. Suitable for this purpose are any acids present in dry form, preferably as a flowable solid or semi-solid. Especially appropriate are C₂-C₂₀ organic mono- and poly-carboxylic acids and especially alpha- and beta-hydroxycarboxylic acids; C₂-C₂₀ organophosphorus acids such as phytic acid; C₂-C₂₀ organosulfur acids such as toluene sulfonic acid; and peroxides such as hydrogen peroxide. Typical hydroxycarboxylic acids include adipic, glutaric, succinic, tartaric, malic, maleic, lactic, salicylic and citric acids as well as acid forming lactones such as gluconolactone and glucarolactone. Most preferred is citric acid. Also suitable as acid material may be encapsulated acids. Typical encapsulating material may include water soluble synthetic or natural polymers such as polyacrylates (e.g. encapsulating polyacrylic acid), cellulosic gums, polyurethane and polyoxyalkylene polymers. By the term “acid” is meant any substance which when dissolved in deionized water at 1% concentration will have a pH of less than 7, preferably less than 6.5, optimally less than 5. These acids preferably at 25° C. are in dry form, i.e. having melting points no less than 25° C. Concentrations of the acid should range from about 0.5 to about 80%, preferably from about 10 to about 65%, optimally from about 20 to about 45% by weight of the total composition.

A second essential component of compositions within the packet is that of an alkaline material. The alkaline material is a substance which can generate a gas such as carbon dioxide, nitrogen or oxygen, i.e. effervesce, when contacted with water and the acidic material. Suitable alkaline materials are anhydrous salts of carbonates and bicarbonates, alkaline peroxides (e.g. sodium perborate and sodium percarbonate) and azides (e.g. sodium azide). Preferably the alkaline material is sodium or potassium bicarbonate. Amounts of the alkaline material may range from about 1 to about 80%, preferably from about 5 to about 49%, more preferably from about 15 to about 40%, optimally from about 25 to about 35% by weight of the total composition.

The effervescent cleanser composition contained in the packet is anhydrous so as to prevent or minimize any gas generation prior to use. By the terms “anhydrous” and “dry” is meant the presence of no more than about 10, 8, 7, 5, 3.5 and optimally no more than 1% water by weight of the total composition. Water of hydration is not considered to be water for purposes of the anhydrous definition. However, it is preferred to minimize, preferably to eliminate any water of hydration.

Advantageously the combined amount of acidic and alkaline materials will be at least about 1.5%, preferably from about 40 to about 95%, optimally from about 60 to about 80% by weight of the total composition.

A third necessary component of compositions according to the present invention is that of a dry surfactant, preferably a dry surfactant solid or semisolid at 20° C. Dry is as defined above. A suitable surfactant for the present invention is sodium cocoyl isethionate. Other useful surfactants include sodium methyl cocoyl taurate and sodium lauryl sulfate. Surfactants may be of the anionic, cationic, nonionic, amphoteric, zwitterionic varieties and combinations thereof. Amounts of the dry surfactant may range from about 0.1 to about 30%, preferably from about 1 to about 30%, optimally from about 8 to about 15% by weight of the total composition.

Other Components:

A variety of skin benefit agents may be included to improve afterfeel properties. Advantageously these substances will be available as anhydrous powders. Alternatively these substances may be liquids deposited upon or into a powdered substrate (e.g. sodium bicarbonate or zeolite) to achieve a resultant dry flowing powder. Within the skin benefit agent scope are several categories of materials. These include emollients, antiaging actives, antibacterials and fungicides, skin lighteners, sunscreens and combinations thereof. Amounts of the skin benefit agents may range from about 0.001 to about 30%, preferably from about 0.1 to about 20%, more preferably from about 0.5 to about 10%, optimally between about 1 and about 5% by weight of the total composition.

Emollients may be in the form of natural or synthetic esters, silicone oils, hydrocarbons, starches, fatty acids and mixtures thereof. Typically the emollient may range in concentration from about 0.1 to about 35% by weight of the total composition.

Silicone oils may be divided into the volatile and nonvolatile variety. The term “volatile” as used herein refers to those materials which have a measurable vapor pressure at ambient temperature. Volatile silicone oils are preferably chosen from cyclic or linear polydimethylsiloxanes containing from 3 to 9, preferably from 4 to 5, silicon atoms.

Linear volatile silicone materials generally have viscosities less than about 5 centistokes at 25° C. while cyclic materials typically have viscosities of less than about 10 centistokes.

Nonvolatile silicone oils useful as an emollient material include polyalkyl siloxanes, polyalkylaryl siloxanes and polyether siloxane copolymers. The essentially non-volatile polyalkyl siloxanes useful herein include, for example, polydimethyl siloxanes with viscosities of from about 5 to about 100,000 centistokes at 25° C. Among the preferred non-volatile emollients useful in the present compositions are the polydimethyl siloxanes having viscosities from about 10 to about 400 centistokes at 25° C.

Among the ester emollients are:

(1) Alkenyl or alkyl esters of fatty acids having 10 to 20 carbon atoms. Examples thereof include isoarachidyl neopentanoate, isononyl isonanonoate, oleyl myristate, oleyl stearate, and oleyl oleate.

(2) Ether-esters such as fatty acid esters of ethoxylated fatty alcohols.

(3) Polyhydric alcohol esters. Ethylene glycol mono and di-fatty acid ester, diethylene glycol mono- and di-fatty acid esters, polyethylene glycol (200-6000) mono- and di-fatty acid esters, polypropylene glycol 2000 monooleate, polypropylene glycol 2000 monostearate, ethoxylated propylene glycol monostearate, glyceryl mono- and di-fatty acid esters, polyglycerol poly-fatty esters, ethoxylated glyceryl monostearate, 1,3-butylene glycol monostearate, 1,3-butylene glycol distearate, polyoxyethylene polyol fatty acid ester, sorbitan fatty acid esters, and polyoxyethylene sorbitan fatty acid esters are satisfactory polyhydric alcohol esters.

(4) Wax esters such as beeswax, spermaceti, myristyl myristate, stearyl stearate and arachidyl behenate.

(5) Sterols esters, of which cholesterol fatty acid esters are examples thereof.

(6) Triglycerides such as sunflower seed oil, maleated sunflower seed oil, borage seed oil and safflower oil.

Hydrocarbons suitable as emollients include petrolatum, mineral oil, isoparaffins and hydrocarbon waxes such as polyethylene.

Starches are also suitable emollients. Typical of this class is tapioca and arabinogalactan.

Fatty acids may also be suitable as emollients. The fatty acids normally have from 10 to 30 carbon atoms. Illustrative of this category are pelargonic, lauric, myristic, palmitic, stearic, isostearic, hydroxystearic, oleic, linoleic, riconleic, arachidic, behenic and erucic acids.

Antiaging actives are also useful as skin benefit agents. Included within this category are vitamins, retinoids and combinations thereof. Amounts of these materials may range from about 0.001 to about 20% by weight of the total composition. Suitable vitamins include ascorbic acid, Vitamin B₆, Vitamin B₁₂, tocopherol as well as salts and C₁-C₂₀ esters thereof. Suitable retinoids include retinoic acid as well as its C₁-C₂₂ esters and salts, retinol and C₁-C₂₂ fatty esters of retinol including retinyl linoleate.

Another class of antiaging actives are the alpha- and beta-hydroxycarboxylic acids and salts thereof. Representative of this group are glycolic acid, lactic acid, malic acid, hydroxyoctanoic acid and mixtures of these as well as their salts. Suitable salts are the alkalimetal, ammonium and C₁-C₁₀ alkanol ammonium salts.

Antibacterials and fungicidals may also be included as skin benefit agents. Representative of these categories are triclosan, tricloban, hexetidene, chlorhexadene, gluconates, zinc salts (e.g. zinc citrate and zinc phenolsulfonate) and combinations thereof.

Skin lighteners may also be included under the skin benefit agents. Typical of this category are niacinamide, kojic acid, arbutin, vanillin, ferulic acid and esters thereof, resorcinol, hydroquinone, placental extract and combinations thereof.

Sunscreens may also be included as skin benefit agents. Particularly preferred are such materials as ethylhexyl p-methoxycinnamate, available as Parsol® MCX, and benzophenone-3, also known as Oxybenzone. Inorganic sunscreen actives may be employed such as microfine titanium dioxide, polyethylene and various other polymers. Amounts of the sunscreen agents will generally range from 0.1 to 30%, preferably from 2 to 20%, optimally from 4 to 10% by weight.

Adjunct functional agents may also be incorporated into compositions of the present invention. These include electrolytes, thickeners and mixtures thereof. Amounts of these substances may range from about 0.1 to about 20%, preferably from about 0.3 to about 10%, optimally between about 0.5 and about 5% by weight of the total composition.

Electrolytes may be selected from alkali, alkaline earth or ammonium salts of phosphates, silicates, halides, sulphates and mixtures thereof. Typical phosphates are potassium polymetaphosphate, sodium tripolyphosphate, sodium tetrapyrophosphate, sodium or potassium pyrophosphate and sodium hexametaphosphate. Most preferred is potassium polymetaphosphate available as Lipothix 100B® which is a 70:30 mixture of potassium polymetaphosphate and sodium bicarbonate, available from Lipo Chemicals, Inc., Paterson, N.J. Preferred sulphates are the magnesium sulphates.

Thickeners which may improve afterfeel properties on skin include inorganic or organic substances. A particularly preferred inorganic thickener is sodium magnesium silicate commercially available as Optigel SH®. Organic thickeners include alginic acid as well as sodium and calcium alginates, sodium carboxymethyl cellulose, hydroxypropyl methylcellulose, hydroxypropyl cellulose, hydroxyethyl cellulose and combinations thereof. Most preferred is alginic acid commercially available as Kelacid® from Sud-Chemie Rheologicals, Louisville, Ky. Alginic acid is highly effective at removing the slimy feel associated with deposits of alkaline material which are not fully rinsed away from the skin. Amounts of the thickener may range from about 0.1 to about 20%.

Polysaccharides useful in this invention are dry solid anhydrous substances such as sorbitol, sugars, (such as trehalose) starches, modified starches (e.g. aluminum octenyl succinate) and mixtures thereof. Most preferred is sorbitol.

Deposition aids may also be incorporated in compositions of the present invention. These assist in depositing skin benefit agents onto the skin surface. Particularly effective are cationic monomers and polymers for this purpose. Illustrative are the following: Lauryltrimethylammonium chloride (Laurtrimonium chloride); Stearyltri(2-hydroxyethyl)ammonium chloride (Quaternium-16); Lauryldimethylbenzylammonium chloride (Lauralkonium chloride); Oleyldimethylbenzylammonium chloride (Olealkonium chloride); Dilauryldimethylammonium chloride (Dilauryldimonium chloride); Cetyidimethylbenzylammonium chloride (Cetalkonium chloride); Dicetyldimethylammonium chloride (Dicetyldimonium chloride); Laurylpyridinium chloride (Laurylpyridinium chloride); Cetylpyridinium chloride (Cetylpyridinium chloride); N-(soya alkyl)-N,N,N-trimethylammonium chloride (Soyatrimonium chloride); Polydiallyldimethylammonium chloride (Polyquaternium-6); Diallydimethylammonium salt copolymerized with acrylamide (Polyquaternium-7); Guar hydroxypropyltrimonium chloride (Guar hydroxypropyltrimonium chloride); Copolymer of N-vinyl-pyrrolidone and N,N-dimethylaminoethylmethacrylate quaternized with dimethylsulfate (Polyquaternium-11); Copolymer of acrylamide and N,N-dimethylaminoethyl methacrylate, quaternized with dimethyl sulfate (Polyquaternium-5); Cationic hydroxyethylcellulosics (Polyquaternium-10); Cationic hydroxyethylcellulosics (Polyquaternium-24); Cetyltrimethylammonium chloride (Cetrimonium chloride); Decyldimethyloctylammonium chloride (Quaternium-24); Myristyltrimethylammonium chloride (Mytrimonium chloride); Polyoxyethylene (2)-cocomonium chloride (PEG-2 Cocomoniumchloride); Methylbis(2-hydroxyethyl)cocoammonium chloride (PEG-2 Cocoyl Quaternium-4); Methylpolyoxyethylene-(15) cocoammonium chloride (PEG-15 Cocoyl Quaternium-4); Methylbis(2-hydroxyethyl) octadecyl ammonium chloride (PEG-2 Stearyl Quaternium-4); Methylpolyoxyethylene-(15) octadecylammonium chloride (PEG-15 Stearyl Quaternium-4); Methylbis(2-hydroxyethyl)-oleylammonium chloride (PEG-2 Oleyl Quaternium-4); Methylpolyoxyethylene-(15)oleylammonium chloride (PEG-15 Oleyl Quaternium-4), The names in parenthesis are given by the Cosmetic, Toiletry and Fragrance Association, Inc. in the CTFA Cosmetic Ingredient Dictionary. Most preferred for purposes of this invention are cationic guar gums such as Jaguar C13S® which is guar hydroxypropyltrimonium chloride. Amounts of the deposition aid may range from about 0.01 to about 1%, preferably from about 0.05 to about 0.5%, optimally from about 0.1 to about 0.3% by weight.

Advantageously an emotive agent such as a fragrance and/or botanical extract are included with the effervescent cleansing composition. Fragrances and botanicals are often liquids. For this reason it is necessary to uniformly distribute and allow absorption of liquid components into the solid powder. One method of best achieving this is to spray these liquids onto the solids. Amounts of the fragrance and/or botanicals combined may be at levels from abut 0.1 to about 3%, preferably from 0.5 to 2%, optimally from 0.8 to 1.5% by weight of the total composition.

The term “fragrance” is defined as a mixture of odoriferous components, optionally mixed with a suitable solvent diluent or carrier, which is employed to impart a desired odor. Particular preferred odoriferous components are cyclic and acyclic terpenes and terpenoids. These materials are based upon isoprene repeating units. Examples include alpha and beta pinene, myrcene, geranyl alcohol and acetate, camphene, dI-limonene, alpha and beta phellandrene, tricyclene, terpinolene, allocimmane, geraniol, nerol, linanool, dihydrolinanool, citral, ionone, methyl ionone, citronellol, citronellal, alpha terpineol, beta terpineol, alpha fenchol, borneol, isoborneol, camphor, terpinen-1-ol, terpin-4-ol, dihydroterpineol, methyl chavicol, anethole, 1,4 and 1,8 cineole, geranyl nitrile, isobornyl acetate, linalyl acetate, caryophyllene, alpha cedrene, guaiol, patchouli alcohol, alpha and beta santalol and mixtures thereof. Botanicals of particular use in the present invention include yarrow, chamomile, jasmine, lavender, horse chestnut, sage, thyme, yucca, coltsfoot and mixtures thereof.

Preservatives can desirably be incorporated into the cosmetic compositions of this invention to protect against the growth of potentially harmful microorganisms. Suitable traditional preservatives for compositions of this invention are alkyl esters of para-hydroxybenzoic acids. Other preservatives which have more recently come into use include hydantoin derivatives, propionate salts, and a variety of quaternary ammonium compounds. Cosmetic chemists are familiar with appropriate preservatives and routinely choose them to satisfy the preservative challenge test and to provide product stability. Particularly preferred preservatives are phenoxyethanol, methyl paraben, propyl paraben, imidazolidinyl urea, sodium dehydroacetate and benzyl alcohol. The preservatives should be selected having regard for the sue of the composition and possible incompatibilities between the preservatives and other ingredients in the emulsion. Preservatives are preferably employed in amounts ranging from 0.01% to 2% by weight of the composition.

Natural vegetable materials from renewable resources are often desirable in cosmetic compositions. For instance, cosmetic compositions of the present invention may include beta-glucan derived from oats, commercially available under the trademark Microat SF from Nurture Inc., Missoula, Mont.

Colorants may also be included in compositions of the present invention. These substances may range from about 0.05 to about 5%, preferably between 0.1 and 3% by weight.

Effervescent cleansing compositions of this invention will be placed in a water soluble or dispersible packet comprising the second substrate or a packet that contains a water-soluble or dispersible portion comprising the second substrate. The packet will in turn be placed within a receptacle formed advantageously between a first and second flexible sheets comprising the first substrate, preferably at least one of these being a flexible sheet. At least one of the sheets must have a portion that is water permeable, most preferably both sheets should have portions that have water permeability. For definitional purposes, first and second sheets can be folded-over panels of a single unitary sheet. Suitable materials for forming sheets may be rayon, polyester, polyethylene, polypropylene, cotton or any combination thereof. These sheets may be woven or non-woven. Most preferred is a non-woven rayon. Cellulosic paper fiber substrates are best not employed because of their insufficient wet-strength although they may be blended with other fibers referenced above; it is important that the first substrate sheets are not readily torn open through consumer rubbing of the article. Unlike laundry sachet articles, the receptacles comprising the first substrate of the present invention should not rupture to allow dispersion of the granular contents contained in the packet to spill undissolved into wash water. Rather it is intended for all cleanser composition components to exit by dissolution through the permeable walls of the receptacle after being released from the packet.

Skin surfaces against which articles of the present invention are useful include face, body, scalp, axilla and even legs/feet. When the article is a foot cleanser, it would be advantageous for the pouch on one of its sides to be coarse while the second of the sheets may be soft and gentle. An abrasive non-woven flexible sheet in a foot cleanser product is useful for rubbing against calluses while the second sheet of the pouch remains smooth.

Articles according to the present invention may be formed in the following manner. Constituents of the effervescent cleansing composition are placed into a dry mill or similar apparatus and blended until a uniformally distributed powder results. Thereafter, fragrance/botanical component as a Phase B is sprayed into the dry mill with concurrent agitation of the powdered composition. The composition is then dispensed into a a packet having a water soluble or dispersible portion and the packet is sealed using art recognized and other equivalent techniques such as thermal sealing, adhesive sealing, ultrasonic sealing, any combination thereof and the like.

A continuous roll of first sheet of the first substrate is unwound from a source roll over a moving conveyer belt. The packets containing the effervescent cleansing composition are placed onto the sheet in a predetermined sequence. A second sheet of the first substrate is then in register placed over that of the loaded first sheet. At this point the periphery surrounding the packet is tacked or sealed in register trapping the effervescent cleansing composition containing packet within. Cutters then separate one tacked or sealed section from another thereby forming the cosmetic article. One or more of the cosmetic articles are then packaged within a moisture impermeable outer package such as a laminated foil bag to prevent degradation of the water soluble or dispersible packet during storage and premature activation of the effervescent system.

Ultrasonic welding may be employed as an alternative to heat-sealing of the first and second sheets of the first substrate together. Spot welding, thread stitching, glue application or other continuous or discontinuous closure mechanisms may also be utilized.

The invention will now be described in greater detail by way of the following non-limiting examples. The examples are for illustrative purposes only and not intended to limit the invention in any way.

Except in the examples, or where otherwise explicitly indicated, all numbers in this description indicating amounts or ratios of materials or conditions or reaction, physical properties of materials and/or use are to be understood as modified by the word “about”.

Where used in the specification, the term “comprising” is intended to include the presence of stated features, integers, steps, components, but not to preclude the presence or addition of one or more features, integers, steps, components or groups thereof.

All percentages in the specification and examples are intended to be by weight unless stated otherwise.

### EXAMPLE 1

An effervescent cleansing composition may be prepared according to the formulation reported in Table I. Phase A may be dry blended in a high speed shearing mixer. Fragrance may then be sprayed onto the resultant powder as a Phase B. Three grams of the resultant powder are then placed into a two inch by three inch packet composed of water soluble polyvinyl alcohol film, the powder is heat sealed within the packet and the packet is is placed into a pouch of slightly larger dimensions formed of non-woven rayon. All sides of the pouch may be closed by double stitching with thread.

TABLE I

| INGREDIENT | WEIGHT % |
|---|---|
| PHASE A | |
| Sodium Bicarbonate | 34.5 |
| Citric Acid (Anhydrous) | 40.4 |
| Sodium Cocoyl Isethionate (Powder) | 11.6 |
| Sodium Sesquicarbonate | 5.0 |
| Lipothix 100B ® (Potassium | 0.5 |
| Polymetaphosphate/Bicarbonate 70:30) | |
| Optigel SH ® (Sodium Magnesium Silicate) | 1.0 |
| Kelacid ® (Alginic Acid) | 1.0 |
| Sorbitol | 5.0 |
| PHASE B | |
| Fragrance | 1.0 |

### EXAMPLE 2

Another effervescent cleansing composition may be prepared according to the formulation listed in Table II according to the procedure in example 1.

TABLE II

| INGREDIENT | WEIGHT % |
|---|---|
| PHASE A | |
| Sodium Bicarbonate | 32.3 |
| Citric Acid (Anhydrous) | 41.1 |
| Sodium Cocyl Isethionate (Powder) | 11.6 |
| Sodium Sesquicarbonate | 5.0 |
| Lipothix 100B ® (Potassium | 0.5 |
| Polymetaphosphate/Bicarbonate 70:30) | |
| Optigel SH ® (Sodium Magnesium Silicate) | 1.0 |
| Kelacid ® (Alginic Acid) | 1.0 |
| Sorbitol | 5.0 |
| Laracare A200 ® (Arabinogalactan) | 1.0 |
| Ascorbic Acid | 0.5 |
| PHASE B | |
| Fragrance | 1.0 |

### EXAMPLE 3

A face cleansing effervescent composition may be prepared according to the formulation listed in Table III according to the procedure in example 1.

TABLE III

| INGREDIENT | WEIGHT % |
|---|---|
| PHASE A | |
| Sodium Bicarbonate | 33.6 |
| Citric Acid (Anhydrous) | 39.0 |
| Sodium Cocyl Isethionate (Powder) | 3.0 |
| Sodium Methyl Cocoyl Taurate | 6.0 |
| Sodium Lauryl Sulfate | 2.5 |
| Sodium Sesquicarbonate | 5.0 |
| Lipothix 100B ® (Potassium | 0.5 |
| Polymetaphosphate/Bicarbonate 70:30) | |
| Optigel SH ® (Sodium Magnesium Silicate) | 2.0 |
| Tapioca | 5.5 |
| Methyl Gluceth 20-Benzoate | 2.0 |
| Guar Hydroxypropyl Trimonium Chloride | 0.25 |
| PHASE B | |
| Fragrance | 0.65 |

### EXAMPLE 4

A still further effervescent cleansing composition according to the present invention may be prepared according to the formulation listed under Table IV. Phase A is prepared by dry mixing of the ingredients in a high speed shear mixer. Three grams of resultant powder are placed into a two inch by three inch packet formed of a water soluble polyvinyl alcohol film having a weight average molecular weight between about 1,000 and about 300,000 and the packet is then sealed with a suitable contact adhesive. The mesh size of the woven or non-woven receptacle containing the packet is sufficient to allow transfer of dissolved ingredients.

TABLE IV

| INGREDIENT | WEIGHT % |
|---|---|
| PHASE A | |
| Potassium Bicarbonate | 29.5 |
| Lactic Acid (Anhydrous) | 45.4 |
| Sodium Sulfosuccinate | 11.6 |
| Sodium Sesquicarbonate | 5.0 |
| Lipothix 100B ® (Potassium | 0.5 |
| Polymetaphosphate/Bicarbonate 70:30) | |
| Optigel SH ® (Sodium Magnesium Silicate) | 1.0 |
| Kelacid ® (Alginic Acid) | 1.0 |
| Sorbitol | 5.0 |
| PHASE B | |
| Fragrance | 1.0 |
| Licorice Extract | 0.1 |

### EXAMPLE 5

Still another effervescent cleansing composition may be prepared according to the formulation listed in Table V. The ingredients are dry blended in a high speed shearing mixer. Fragrance and herbal extract are sprayed onto the powder and further blended to achieve homogeneity. Three grams of the resultant powder are placed into a two inch by three inch packet formed of a water soluble polyvinyl alcohol film having a weight average molecular weight between about 1,000 and about 300,000 and the packet is heat sealed. The sealed packet is itself sealed in a non-woven polypropylene receptacle via convection heat sealing along the perimeter thereof.

TABLE V

| INGREDIENT | WEIGHT % |
|---|---|
| PHASE A | |
| Sodium Bicarbonate | 29.5 |
| Citraconic Acid (Anhydrous) | 45.4 |
| Methyl Glucamide | 11.6 |
| Sodium Sesquicarbonate | 5.0 |
| Lipothix 100B ® (Potassium | 0.5 |
| Polymetaphosphate/Bicarbonate 70:30) | |
| Optigel SH ® (Sodium Magnesium Silicate) | 1.0 |
| Kelacid ® (Alginic Acid) | 1.0 |
| Sorbitol | 5.0 |
| PHASE B | |
| Fragrance | 0.9 |
| Yarrow | 0.1 |

### EXAMPLE 6

Still another effervescent cleansing composition may be prepared according to the formulation listed in Table VI. The ingredients are dry blended in a high speed shearing mixer. Fragrance and herbal extract are sprayed onto the powder and further blended to achieve homogeneity. 3 to 3.5 grams of the resultant powder are placed into a two inch by three inch packet formed of a water soluble polyvinyl alcohol film having a weight average molecular weight between about 1,000 and about 300,000 and the packet is heat sealed. The sealed packet is itself sealed in a non-woven receptacle via closwely spaced spot welds along the perimeter thereof.

TABLE VI

| INGREDIENT | WEIGHT % |
|---|---|
| Citric Acid Anhydrous | 24 |
| Sodium Bicarbonate | 24 |
| Maltodextrin | 9.49 |
| Calcium Silicate | 7 |
| Guar Hydroxypropyltrimonium Chloride | 5 |
| Polyethylene Glycol 180 | 5 |
| Sodium Lauryl Sulfoacetate | 3.75 |
| Sodium Cocoyl Isethionate 78% | 3.75 |
| Sodium C14-16 Olefin Sulfonate | 3.75 |
| Polyoxyethylene, Polyoxypropylene Block Polymer | 3 |
| Sodium Stearoyl Lactylate | 3 |
| Mineral Oil | 3 |
| Sodium Stearate | 3 |
| Disodium Peg12 Dimethicone Sulphonate | 1 |
| Dimethyldiallyl Ammonium Chloride.Acrylamide | 0.5 |
| Copolymer | |
| Fragrance | 0.5 |
| Isocetyl Behenate | 0.2 |
| Vitamin E Acetate | 0.02 |
| DI-Panthenol | 0.02 |
| Vitamin A Palmitate | 0.01 |
| Helianthus Annuus (Hybrid Sunflower) | .01 |
| Total | 100 |

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention.

What is claimed is:

1. A cosmetic article for cleansing the skin and hair, the article comprising:
a. a water permeable first substrate defining at least a portion of one wall of a receptacle;
b. a second substrate defining a unitary chamber positioned in the receptacle, the second substrate having a water soluble or dispersible portion;
c. an anhydrous effervescent cleanser composition being positioned within the unitary chamber, the composition including:
(i) from about 1 to about 80% of an alkaline material;
(ii) from about 0.5 to about 80% of an acid material;
(iii) from about 0.1 to about 30% of a surfactant; and wherein the alkaline and acid materials are blended together within the unitary chamber.

2. The article of claim 1 wherein the first substrate is selected from woven or nonwoven materials; other natural or synthetic polymeric materials or any combination of the foregoing.

3. The article of claim 1 wherein the first substrate is a fibrous substrate.

4. The article of claim 1 wherein the second substrate is selected from natural or synthetic water-soluble materials or a blend thereof.

5. The article of claim 4 wherein the second substrate is selected from polyvinyl alcohol, cellulose ethers, polyethylene oxide, starch, polyvinylpyrrolidone, polyacrylamide, polyvinyl methyl ether-maleic anhydride, polymaleic anhydride, styrene maleic anhydride, hydroxyethylcellulose, methylcellulose, polyethylene glycols, carboxymethylcelulose, polyacrylic acid salts, alginates, acrylamide copolymers, guar gum, casein, ethylene-maleic anhydride resin series, polyethyleneimine, ethyl hydroxyethylcellulose, ethyl methylcellulose, hydroxyethyl methylcellulose, esters of polyvinyl alcohol, lactic acid ethers or esters of cellulose derivatives, lactic acid grafts on polyvinyl alcohol, carrageenan, pectin, or combinations or derivatives thereof.

6. The article of claim 1 wherein the second substrate has an average thickness in the range of about 10 to 125 microns.

7. The article of claim 1 wherein the effervescent cleanser composition further comprises from about 0.01 to about 30% by weight of a skin benefit agent selected from emollients, anti-aging actives, antibacterials and fungicides, skin lighteners, sunscreens or mixtures thereof.

8. The article according to claim 7 wherein the anti-aging actives are selected from vitamins, retinoids or mixtures thereof.

9. The article of claim 1 wherein the effervescent cleanser composition further comprises about 0.1 to about 3% by weight of an emotive agent selected from the group consisting of fragrance, botanical extracts or mixtures thereof.

10. The article of claim 9 wherein the emotive agent is incorporated into the effervescent cleanser composition by spray application onto one or more other components of the composition.

11. The article of claim 1 wherein the water permeable first substrate is a non-woven rayon.

12. The article of claim 1 wherein the second substrate defining the unitary chamber is a water soluble polyvinyl alcohol polymer.

13. The article of claim 1 wherein the surfactant includes sodium cocoyl isethionate.

14. The article of claim 1 wherein the acid includes citric acid.

15. The article of claim 1 wherein the effervescent cleanser composition further comprises about 0.01 to about 1% by weight of a skin deposition aid which is a cationic monomer or polymer.

16. A cosmetic article for cleansing body surfaces, the article comprising a substantially sealed pillow plumped by effervescent generated carbon dioxide and exuding lather and an emollient through a water permeable first substrate wherein the article contains a second substrate defining a unitary chamber positioned in the pillow, the chamber containing an effervescent composition, and the second substrate having a water soluble or dispersible portion.

17. A method for cleansing skin comprising the steps of:
a. wetting with water a cosmetic cleansing article,
b. generating foam from the article and
c. wiping skin surfaces with the wetted article, wherein the article includes:
1. a water permeable first substrate defining at least a portion of one wall of a receptacle;
2. a second substrate defining a unitary chamber positioned in the receptacle, the substrate having a water soluble or dispersible portion;
3. an anhydrous effervescent cleanser composition being positioned within the unitary chamber, the composition including:
(i) from about 1 to about 80% of an alkaline material;
(ii) from about 0.5 to about 80% of an acid material;
(iii) from about 0.1 to about 30% of a surfactant; and wherein the alkaline and acid materials are blended together within the unitary chamber.
